(19) United States
(12) Patent Application Publication
(10) Pub. No.: US 2004/0111346 A1
(43) Pub. Date: Jun. 10, 2004

(54) Methods for automating financial transactions

(76) Inventors: Keith S. Macbeath, New York, NY (US); Adam L. Dener, Westport, CT (US)

Correspondence Address: CHARLES G. CALL, 68 HORSE POND ROAD, WEST YARMOUTH, MA, 02673-2516, US

(21) Appl. No.: 10/723,925

(22) Filed: Nov. 26, 2003

Related U.S. Application Data
(60) Provisional application No. 60/429,589, filed on Nov. 27, 2002.

(51) Int. Cl. G06F 17/60

(52) U.S. Cl. 705/35

(57) ABSTRACT

A method for providing extended data processing services from a bank to its business customers that are engaged in commercial supply chain business transactions. A standard common data model defines the content of data describing individual financial payment transactions performed by the bank on behalf of its customer, and well as additional “rich data” specifying the nature of the underlying commercial supply chain transactions between the bank's customer and its customers and suppliers that give rise to each financial payment transactions. The database is accessed and utilized by the banks customers which employ Web service routines to implement conventional banking functions such as lockbox, checking and electronic payment, lending and cash management services, and to perform further data processing operations using the data that conforms to the common data model, including accounts receivable and accounts payable management functions, collections management, integrated credit assessment and management, payments workflow and purchasing functions, and sales decisioning support.

### CROSS REFERENCE TO RELATED APPLICATIONS

This application is a Non-Provisional of U.S. patent application Ser. No. 60/429,589 filed Nov. 27, 2002.

### FIELD OF THE INVENTION

This invention relates to data processing methods and apparatus for executing, recording, analyzing and managing commercial and financial transactions.

### SUMMARY OF THE INVENTION

In its preferred embodiment, the present invention takes the form of a method of providing data processing services from a bank to a client business organization engaged in commercial supply chain business transactions. A standard common data model is established which defines the content of data describing individual financial payment transactions performed by the bank on behalf of its customer, and well as additional “rich data” specifying the nature of the underlying commercial supply chain transactions between the bank's customer and its customers and suppliers that give rise to each financial payment transactions.

The bank establishes a database system for storing data that conforms to said standard data model, and employs the database system to accept payment instruction data from its customer business organization to perform specified payment transactions. In the preferred embodiment, the data from the customer business organization is captured by Web service cash workflow functions which are made available to the bank's customer as extended services which are integrated with the bank's traditional lockbox, checking and electronic payment, lending and cash management services.

In accordance with the invention, the database system that conforms to the standard data model captures and processes additional data specifying the nature of the underlying commercial transaction between said business organization and its customers and suppliers. In response to requests from the customer, submitted as Web service requests, the bank's database system further makes available a plurality of data processing operations using the data that conforms to the common data model, including accounts receivable and accounts payable management functions, collections management, integrated credit assessment and management, payments workflow and purchasing functions, and sales decisioning support.

These and other features of the invention may be better understood by considering the following detailed description of a preferred embodiment of the invention.

### BRIEF DESCRIPTION OF THE DRAWINGS

In the detailed description which follows, frequent reference will be made to the attached drawings, in which:

FIG. 1 is a data flow diagram illustrating the manner in which the common data model is employed to implement processes between banks and their corporate customers as well as transactions between corporations;

FIG. 2 is a more detailed data flow diagram depicting the manner in which the common data model operates within externally facing commercial and financial activities of corporations.

FIG. 3 is a diagram illustrating the logical operation of the invention; and

FIG. 4 is a block diagram illustrating the manner in which capital management processes performed by corporations are implemented as an extension to current bank processes;

### DETAILED DESCRIPTION

1. Introduction

1.1 Purpose

The detailed description which follows provides a high-level specification for a specific embodiment of the invention, which will be referred to as “EnterCap” or the “EnterCap solution.” EnterCap consists of the “EnterCap Data Model” and the “EnterCap Business Model.” The description below defines the scope of use of these two components of the EnterCap solution, what each is and how it works, as well as how it can be maintained. The manner in which instances of the data model can be implemented within individual software installations, and how the instances can maintain alignment with the master model, will also be described. The description that follows provides a specification for building the data model that will be used in common by customers to facilitate interoperation of different systems and software routines, in the context of automating financial processes in business, in cases both of cash and of credit, and for both transactions and analysis.

1.2 Scope

EnterCap is intended to be used to facilitate the automation of the financial supply chain by enabling a high degree of interoperability among processes within and among organizations using a data-centric workflow platform. This will allow integration at lower cost than has been achieved by manual or software-centric approaches.

The EnterCap Data Model will allow the achievement of low-cost inter-operation among processes by being the model that all external processes map to and from. The data model enables assimilation across an organization of externally-facing financial processes by: (a) providing logical mapping of commercial transactions to financial transactions and (b) enabling aggregation and tracking of the financial transactions across the organization.

The EnterCap Business Model entails solutions employing this business model being marketed as value-added services to corporations by banks. In this way, banks serve the traditional need that they have addressed for corporations in managing working capital, but through driving efficiency rather than funding inefficiency. Using EnterCap, the banks will add value to their payments businesses, since EnterCap builds on these, and they will reduce corresponding their corporate lending business. This change of approach to working capital is designed to increase the profitability of both banks and of their corporate customers by driving efficiency gains and by reducing risk for both parties.

In addition, the EnterCap Platform will generate, on a large scale, event-driven corporate data derived from commercial payments and receipts. This event-driven data, relevant to credit risk, will increase the transparency necessary for a liquid market, enabling banks to securitize corporate credit for a wider range of corporations.

The EnterCap Data Model specified in this document refers to the master data model and not to any specific instance of it in use.

1.3 Definitions, Acronyms, and Abbreviations

As used herein, unless the context otherwise requires, the following terms have the following meanings:

ACH: Automated Clearing House: a low cost electronic payment system (in the US, with equivalents in many developed countries)

assimilation: the integration of a set of processes into a common methodology

CRM: customer relationship management—software for increasing sales effectiveness

Dashboard decisions: decisions made possible by assessing performance and exceptions data aggregated across a business unit or enterprise in real-time or on an event basis by a system

data-centric: referring to information systems solution in which a data model, as opposed to a software application, is considered the central component of the architecture. A data-centric solution is managed for data model consistency regardless of the software version, and not the other way around.

EnterCap data model: the common data model that EnterCap applications operate upon

EnterCap platform: the workflow architecture of EnterCap

ERP: Enterprise Resource Planning; software for managing manufacturing and other resources from suppliers through to final inventory and sales

Financial Supply Chain: the set of financial processes associated with the buying and selling of goods and services throughout a commercial supply chain (parallel to the physical supply chain)

interoperation: the passing of data, including state change, among disparate systems

process: a commercial activity resulting in an information state change

rich data: data associated with a commercial transaction beyond the financial settlement data (i.e., more than bank account, amount and date)

semantic congruence: exactly matching data references where the data comes from different systems

SWIFT: a bank consortium company that provides international inter-bank electronic payments

XML: eXtensible Markup Language: the W3C standard (syntax) for structured data

2. Overall Description

2.1 Solutions for the Finance Function with a Differentiated Operational Model

2.1.1 Commercial Logic for EnterCap Solutions Marketed to Corporations by Banks

The EnterCap business model provides the framework for products and services that employ this business model which may be marketed as value-added services to corporations by banks. In this way, banks serve the traditional need that they have addressed for corporations in managing working capital. Traditionally, the role of banks was confined to lending. In the EnterCap business model, banks address working capital management for corporations not only through lending but also through the provision of risk-management tools. Using EnterCap, the banks scale their payments business, since the EnterCap platform is built onto payments services, and reduce their corporate lending business at the same customer and in the aggregate.

This change of approach to working capital will increase the profitability of both banks and their corporate customers. In the case of banks, on a risk-adjusted return on capital basis, in general their corporate payments business is value-creating while their corporate lending business is value-destroying. In the bank's payments business, EnterCap increases value-added for customers and increases customer switching costs, increasing the profitability of the payments business and its proportion of the bank's revenue mix from corporate customers. At the same time, as the corporation benefits from efficiency gains in working capital management, its need for bank lending reduces, reducing lending in the bank's revenue mix from corporate customers.

For corporate customers, gains come from increased efficiency and predictability in the use of working capital. While the corporation will pay to use EnterCap risk management tools, the cost will be more than offset by reduced borrowing costs, reflecting both reduced amount borrowed and potentially a better credit score from the bank given the increased transparency and predictability of financial risk in the business. In addition, the corporation will have greater control of its working capital consumption given its ability using EnterCap tools to quantify financial risk and track changes in real-time across its business. This reduces unforecast financial volatility driven by external factors, such as changes in creditor behavior, which have traditionally led to earnings surprises that are as unwelcome to managers as they are to investors. At the same time, the corporation's financial risk is reduced by decreasing its borrowing requirement and leverage for an equivalent scale of business.

2.1.2 Enterprise-Wide and Data-Centric

EnterCap provide enterprise-wide working capital management solutions for corporations. EnterCap may be adopted directly by large corporations (e.g. corporations with revenues greater than US$ 1 billion) and provided through banks to other corporations and small businesses. It will enable ‘dashboard decisions’ for all actions affecting working capital whether in finance, sales or purchasing.

The enterprise-wide working capital solution of EnterCap differs from conventional systems in a number of respects. Firstly, it links all aspects of financing that affect working capital, in particular covering management both of a company's cash position and of its granting of credit to customers (vendor financing). From a systems perspective, this entails interoperation between a cash management solution and a credit management solution, which have hitherto been separate products. Secondly, EnterCap focuses on enterprise-wide solutions, providing services to commercial operations in all subsidiaries as well as to the central corporate treasury; by contrast, existing treasury management software focuses on services for a single treasury operation, with input-output links to others, making them departmental rather than enterprise-wide solutions. Thirdly, EnterCap is a service solution that may be hosted by the user organization or by a third party provisioner, such as a bank. Finally, where appropriate EnterCap will redistribute data accumulated in the course of business, enabling greater transparency and fostering more data-driven decision-making.

To achieve this degree of scalability and interoperability, EnterCap operates on a data-centric and not a software-centric basis, and as a ‘web service’. The EnterCap Data Model is critical to this data-centric approach. In the short-term, installation by installation, it provides the basis for rapid set-up of client rules that then operate. This contrasts with the tight coupling of applications to a specific data environment seen with traditional solutions. In the medium-term, as the EnterCap Data Model is widely adopted, the opportunity arises for more direct inter-operation, and for data extraction.

2.1.3 Bank Delivered

For most corporations, EnterCap will be delivered as a service option from the corporation's primary bank. It is therefore important that the solutions lend themselves to bank hosting and are compatible with the bank's data structures and semantics. In most cases the solutions will operate over electronic payments solutions provided by the bank. For example, the EnterCap solution may layer over an electronic version of the bank's lockbox access service.

The interoperability offered by the data model approach is critical to making it cost effective for a wide range of banks to deploy EnterCap. In addition, the data model may enable banks to offer further integration among their service offers to customers, which tend to operate in product silos today.

2.2 Product Perspective

From a product perspective, EnterCap is a web services platform for cash and credit workflow and analysis, enabling virtual applications to operate through a common data model. The platform is architected on data and workflow, with applications consisting of configurations of business rules at each appropriate point of operation within workflow. EnterCap provides a data model as well as sets of business rules for cash management and credit management from which application instances can be configured by customer organizations.

2.3 Product Functions

EnterCap's capabilities are focused on six specific functional areas: (1) cash workflow; (2) credit assessment; (3) integrated credit management; (4) accounts receivable/collections management; (5) sales decisioning; and (6) data-centric process integration.

Cash Workflow serves the treasury function at any level in the enterprise, both within operating units and at the corporate centre, supporting cash position forecasting and reconciliation, providing internal and external data connectivity that is both enterprise-wide and event-driven, and providing ‘straight-through’ connectivity to banks for transaction initiation. In addition, Cash Workflow supports enhanced decision-making by combining external market data and leading analytics within the customer context.

Credit Assessment facilitates credit-granting decisions to customers or prospects that are corporations, to better manage risk in vendor financing. Credit Assessment provides a support tool for credit decisions integrating internal and external data concerning exposure, cost and behavioral history.

Integrated credit management supports improvement of overall credit portfolio risk and management of that risk, integrating credit exposure data built from individual transactions, credit history derived from transactions, and related external data. The portfolio assessment seeks to mitigate concentrations of risk whether in companies, sectors, geographies or other identified correlations.

Accounts receivable/collections management builds on bank payments services such as lockbox to provide greater efficiency and effectiveness in collections. The EnterCap solution enables the providing bank to match incoming payments with expected payments, tracking collection and comparing it to the behavioral model for each customer, alerting exceptions on an event basis and updating the integrated credit management process, feeding back into credit assessment and sales decisioning as appropriate.

Sales decisioning builds on credit assessment to provide a ‘dashboard decision tool’ that is provided to a front-line commercial operation within sales workflow to maximize profitability of sales. Sales decisioning covers both prospecting, helping sales staff to include credit risk issues in choosing where to direct sales effort, and authorization at the point of sale: the authorization levels can be flexibly configured based on the workflow required by the user organization and operate, for example, automatically for a sales executive or routed through a sales manager or a general manager. Whatever authorization is implemented, the credit created will be captured for servicing and portfolio analysis. Exceptions handling, routing to a credit officer or finance officer, is configured within workflow.

Data-centric process integration underlies the ability of the above services to interoperate, both among themselves and with other process of the customer organization (such as software for Accounting, ERP or CRM) and with process of supplier organizations as banks and logistics suppliers. Each process consists of a configured application instance working off a normalized data set. A key feature of the EnterCap solution is that any subsequent process that is implemented is another configured application instance but operating over the same normalized data set as that used by the first process to be implemented.

2.4 User Characteristics

2.4.1 Users in Corporations

The EnterCap solution addresses the needs of corporations at a number of levels, meeting policy goals of senior executives at the same time as improving task efficiency for staff. Even for senior executives, EnterCap provides ‘dashboard’ access to data that can improve the effectiveness and timeliness of control, performance review and risk analysis.

CEO—Sponsor, Indirect User:

For corporations, linking commercial transactions within operating subsidiaries directly to corporate treasury reduces the amount, volatility and cost of working capital, which represents 65% of corporate assets on average. Historically this cost-benefit analysis may not have been well understood outside the finance function; in today's environment, the increased transparency and better control of risk afforded by direct linkage of capital processes throughout the enterprise are compelling benefits in themselves for the entire management team.

CFO—Sponsor, Occasional User:

For the CFO, EnterCap provides control, efficiency, risk reduction and compliance benefits. Significant strides have been made in recent decades in reducing working capital consumption in the physical supply chain using just-in-time manufacturing techniques and management systems such as ERP. However, there has been less progress in integrating financial processes that are generated by commercial actions in the supply chain. In addition, ERP systems are typically not enterprise-wide, but subsidiary-specific, often operating on incompatible data models making integration costly. Acquisitions tend to add additional incompatible systems. This leaves the CFO in the position of not having consistent systems at any one time.

EnterCap, by allowing the rapid set up of interoperation among unrelated systems, enables systems to be ‘virtually consistent’ for the purposes of working capital management, which has a series of implications for the CFO: (a) control and compliance: control is no longer limited to policy issuance and periodic audits; (b) efficiency: on-line reconciliation among multiple systems and commercial partners (banks, customers, suppliers) is on-line, which is less costly and more timely than off-line processes; working capital process or analytical changes can be implemented more rapidly across the enterprise; best practices in cash and credit management are more easily replicated; risks are reduced; and cash and credit issues are aggregated at the center an on event-driven basis, as opposed to periodically in retrospect.

Being ‘virtually consistent for the purpose of working capital management’ is achieved by mapping data from discrete systems implemented for other purposes into the EnterCap solution at each point where cash or credit events occur. The EnterCap data model is critical to this data mapping, and hence critical to the benefit of achieving more rapid, more cost-effective interoperation—so rapid and cost-effective that it becomes economically feasible to maintain an on-line, event-driven view of working capital causes and effects across the entire enterprise. Gaps may occur temporarily following acquisitions or other major structural events but these can be closed in weeks or months, depending on the size of the acquired operations, rather than years.

Corporate Treasurer Sponsor, Frequent User:

Many of the negative implications of system disparity that affect outcomes of concern to the CFO also affect the daily performance of the Treasurer, both in cash management and funding. While cash management is clearly the responsibility of the Treasurer, he or she is often not specifically responsible for vendor financing issues, for example in the case that credit managers report through to the Controller. But since the Treasurer has an overall responsibility for working capital management, he or she has a direct interest in vendor financing as the balance of using it and granting it materially affects the funding of the company.

For the Corporate Treasurer, system disparity, or even lack of systems, has been a fact of life. A majority of large corporations do not even have a treasury management system, although in most such cases they will have implemented spreadsheet macros to conduct analysis, leaving workflow unaddressed.

Treasury has typically had little systems support, for a variety of reasons:

(a) treasury's needs have been relatively hard to understand by those outside the financial function;

(b) until recently, in treasury there was little regulatory compliance that could be systems-assisted;

(c) treasury's needs did not map well to the ‘needs bias’ of the IT function, which has been toward large, departmental solutions (ERP and so on) or mass installation of industry-standard packages (word processing, spreadsheets and so on) whereas, by comparison, treasury's need appeared esoteric, requiring IT to develop applications specialists supporting what appeared to be a small number of users; and

(d) before the emergence of web services, inter-departmental workflow management was costly and difficult to achieve.

EnterCap addresses these needs by providing the Treasurer with a dashboard of financial balance—an event-driven view of the cash and credit position of the company—and as importantly the means to influence it more rapidly and profoundly. The EnterCap data model is critical to the operation of this dashboard since rapid integration makes possible the continuous connectivity to discrete business unit systems, and to third parties such as banks, customers and suppliers. In addition the web services-model makes it possible to spread consistent, managed access to tools that support best practices in operations and risk management to hundreds of users at different levels in the organization, who may be geographically dispersed.

Cash Manager, Continuous User:

EnterCap supports the daily needs of cash managers. While the cash manager's responsibility is to make short-term investment or funding decisions, most of the time of his or her team is taken up by the tasks of establishing the current cash position and collating cash forecasts. These tasks require extensive data gathering from subsidiaries and locations and from the company's banks, as well as reconciliation among these sources and records internal to the cash management team.

The EnterCap solution largely automates both data gathering and reconciliation by mapping multiple sources to the EnterCap data model. Staff in subsidiaries will originate forecasts through web access to the EnterCap system, using a common process that provides direct workflow response to them from the corporate centre, reducing the need for ad-hoc e-mails or faxes. In addition, where cash management is decentralized staff in subsidiaries can have access to the same workflow, automation and analysis tools as the corporate centre, while aggregation to the centre becomes automatic.

Credit Manager, Continuous User:

The underwriter is a key decision-maker in working capital workflow. For all credit decisions, other than those which are automated, credit workflow funnels decision to the underwriter. In addition, the underwriter will advise on what types of decisions may be automated and is likely to be responsible for configuring the decision tool. The underwriter will have responsibility for the portfolio of credit risks assumed by the corporation and will therefore be a primary user of the portfolio management tool and for configuring portfolio influence on credit decisions

The fundamental impact of EnterCap on the credit function and the credit process within the corporation is to make it more rapid and more systematic, which means data-driven, consistent, and transparent. The systematic process makes it possible to compare performance across business units as well as enhancing accountability for decision-makers at each stage. Audit trails are clear and easy to access.

The primary benefit of EnterCap on the credit process is the speed, adherence to standards and accountability provided by on-line workflow, as well as the systematic data capture it provides. Credit decision within the workflow can be assigned to an authorized line manager, credit manager or underwriter, or in some cases can be automated by an application where predictive modeling is possible and accepted by management.

In credit analysis, decisions are materially driven by payment history, which is derived from cash actions over time. The detail of the EnterCap business model makes it suitable to the cash tasks within business units that are analyzed for credit behavior and predictive modeling. It allows behavior analysis to distinguish between ‘justified’ or ‘not justified’ failure to complete timely payments. ‘Justified’ payment failure is caused by such issues as fulfillment problems, whether due to production errors or delivery errors, mistakes with invoices either in items or quantities or invoiced party or invoice date, price, volume and breaches of contracted process.

Collections Manager, Continuous User:

The Collections Manager is responsible for expediting the collection of past due payments from customers. In many corporations, this is in fact the principle focus of the Credit Management function since the need to ‘get cash in’ is unarguable—ironically, the weaker a credit management function is, the greater the amount of time likely to be spent on collections (credit recoveries) as opposed to credit management (pro-active controlling of credit risk). In the collections area, EnterCap can assist companies to pro-actively manage collections themselves, allowing the collections manager to improve collections performance overall rather than focusing primarily on the highest-profile collections issues (largest, longest-overdue receivables). In many corporations, systematic tracking of collections is not complete, so that persistent but not exceptional late payment may not be dealt with. EnterCap will provide the systematic tracking and analysis of all collections, allowing the collections manager to improve days sales outstanding by better targeting of collections activity, including automation of reminders and so on, and providing a basis for identifying patterns of late payment. Investigation of such patterns will allow management to identify opportunities for process improvement in the supply chain, the benefits of which can accurately costed.

Sales Executive, Continuous User:

Terms—essentially credit provision—can make a significant difference to the profitability of a sale, and in extreme cases the viability of a business. Equally, like any other component of a deal, terms can be important in a competitive market. As a result terms must be managed and ideally compared in a systematic and quantified way with other variables in a negotiation. Because this quantification is a specialized task, traditionally it has not been flexibly applied—management of terms is either too rigid, which may affect sales performance, or flexible in too random a manner, which may affect profitability or viability and is one of the drivers of unplanned volatility in working capital. EnterCap brings the sales executive into efficient credit workflow, allowing him or her to receive fast, flexible and systematic credit decisions. In addition, the portfolio capability of EnterCap can allow the sales executive to be pro-active in seeking prospects that are desirable from a credit perspective, either in absolute terms or in terms of portfolio balance, allowing sales staff to factor credit issues into their use of time.

Purchasing Executive, Continuous User:

In terms of cash flow and hence effect on working capital consumption, the terms obtained by the purchasing manager are the obverse of those granted by sales. Again, terms should be quantifiably set off against variables such as price, and EnterCap enables purchasing staff to see these trade-offs, and set them against the funding priorities of the company.

Sales Manager, Business Unit Manager, Purchasing Manager, Finance Manager Sponsor, Frequent User

Superior financial performance benefits all operational managers. Depending on the incentives, performance evaluation and authorization processes of each company, these managerial roles may use EnterCap for performance and/or control purposes. EnterCap allows them to offer faster, more transparent processes to operational staff which drives improved performance. In addition, they may be in the authorization path. Finally, EnterCap allows them to analyze final impacts and trade-off to compare performance among staff and modify policy as frequently as is appropriate.

2.4.2 Bank Users

For banks, EnterCap provides a better answer to compliance and performance pressures on corporate banking. Today the relationship between the bank and its corporate customers is likely to be strictly transactional around banking products, putting the bank in the position of providing payments products related to the company's commercial transactions, and providing lending products to fund working capital (working capital excludes asset financing, investment banking, and other specialized bank services).

In most cases, corporate lending is not profitable for banks after the cost of capital is factored in, while payments products are highly profitable. Banks address this issue by effectively packaging these products in a relationship, but nonetheless corporate banking provides poor returns compared to consumer banking or investment banking.

The marketing of EnterCap provides banks with an alternative approach their corporate customers' working capital needs. As opposed to funding them, however inefficient they may be, the banks offers solutions to make the corporation's working capital processes more efficient, building on the payments products through which all working capital flows. By providing EnterCap as a value-added solution, the bank can reduce the corporate customer's operating costs at the same time as improving the profitability to the bank of the relationship.

CEO, Sponsor:

While commercial banking has long been a drag on bank performance on a capital-adjusted basis, changes in regulation and the regulatory climate are raising the priority of the need to improve it. On the one hand, Basel II provisions will provide strong incentives for banks to manifest superior risk-management processes to regulators and investors. At the same time legislators in the US may raise the bar on compliance with provisions against ‘tying’ lending to other bank products. EnterCap will allow banks to provide an alternative to increased lending that is effective for both banks and their corporate customers. The EnterCap alternative also provides a platform for increased transparency of data and process that can enable superior risk management.

EnterCap enables the CEO to pursue a differentiated strategy in commercial banking that will drive outperformance and reduce risk.

Head of Commercial Banking, Sponsor

EnterCap enables the head of commercial banking to follow a differentiated strategy that improves performance across a range of commercial banking products, and makes corporate relationships more profitable. In fact, by relating banking products across silos into a more effective working capital solution throughout the corporation, EnterCap is able to deliver on the promise of relationship banking with cross-product added value for the customer rather than simply cross-product price breaks.

For payments and cash management products EnterCap reduces operating cost for the bank by driving the on-line origination of transactions, as well as improving profitability by reducing customer churn, since integration into workflow increases the customer's cost of switching banks. Currently, on-line is one payment option among a range that customers may use, with checks or PC Banking being the principal alternatives. Indeed banks have a problem in the proliferation of channels and corporate customers have been reluctant to move from PC Banking services which are costly for banks to support. The integration of payments into an on-line workflow, whereby payment execution is the final stage of a financial decision, makes the execution of payments on-line both easier than alternatives since it is automatic, and more desirable than alternatives since the rich transfer of data allows for greater efficiency in the interaction with suppliers.

In addition, providing value-added services associated with payments to corporate customers embeds the bank into corporate processes. Since the customer has reduced processing costs, yet increased costs of switching banks, the bank is able to resist pricing pressure: linking into workflow retards the commoditization of banking.

For lending products EnterCap drives similar benefits. Systematizing both cash management and credit management and linking them has the effect of significantly reducing the consumption of working capital, saving the corporation borrowing costs and ironically increasing the profitability of the bank by reducing lending as a proportion of its corporate business. Some banks, having recognized the value destruction for their shareholders in corporate lending, have already targeted reducing it: EnterCap allows those banks to retain the profitable dimensions of their corporate relationships by providing solutions that cause customers to reduce their need to borrow, rather than simply being ‘cut off’ by the bank. In addition, EnterCap enables event-driven transparency: with a workflow platform in place, corporations have event-driven data ready

for publication, and they can choose how much to publish and to whom. If they allow banks and fixed income investors to access it, they may lower their cost of borrowing.

Underwriter, Continuous or Periodic User:

Banks may use EnterCap as a workflow and analysis tool to manage loan origination within their own organization—in this case the role of the underwriter is similar to that of the Credit Manager in a corporation, although he or she is less likely to be involved in collections. In addition, where corporations choose to permit their bank to receive it, access to systematic and event-drive EnterCap data from the corporation can significantly reduce the default risk to the bank in that it will provide more timely warning of changing circumstances.

Risk Manager, Sponsor:

The benefit to the Risk Manager of EnterCap is that it can reduce the size of lending exposure and improve credit quality within the portfolio of loans without weakening customer relationships. As part of a strategy for corporate banking, EnterCap can help banks to reduce corporate lending exposure while strengthening customer relationships by focusing the bank on providing solutions that increase corporate customer's working capital efficiency as opposed to the bank funding their inefficiency. Equally, the more timely disclosure enabled by EnterCap can reduce the bank's risk in lending.

Relationship Officer, Periodic User:

The Relationship Officer is key to the bank's marketing of EnterCap. In a bank where remuneration is based on risk-adjusted return on capital, the Relationship Officer will have a direct interest in promoting a product from the bank the reduces capital consumption in the corporate relationship. In the case that the corporation uses EnterCap to release additional information to the bank, the relationship officer may use that data in an advisory capacity.

Cash Management Product Sales Executive, Periodic User:

The EnterCap business model entails solutions for working capital management being marketed as value-added services to corporations by banks. By providing EnterCap to corporate customers, the bank will scale its payments business within a corporate banking relationship, since the EnterCap platform is built onto payments services, and reduce its lending business within a corporate relationship. The efficiency gains to the customer are such that their banking relationship is enhanced rather than strained by this change.

Viewed from the bank's product perspective, EnterCap solutions build on traditional valued-added products in the bank's payment business. Although many banks have developed cash management services for customers that integrate bank account information, there has been little development by banks of services that link cash outcomes to the commercial events that drive them. In addition, bank services have tended to remain in ‘product silos’ that do not easily inter-connect at an information level, constraining their value to the customer.

EnterCap will build additional workflow and analysis components onto traditional bank payments products, moving up the ‘process stack’ within corporations. It will be the responsibility of the Cash Management Product Sales Executive to sell up the value chain in this way. The research for the EnterCap solution provides market segmentation and ‘inflection point’ guidelines that indicate likely hot prospects for EnterCap solutions, identified separately for cash management (value added on payables products) and credit management (value added on receivables products). Using the research as a tool for prospecting, the cash management product sales executive will be responsible for closing customer sales of EnterCap value-added solutions for the bank.

2.5 Constraints

2.5.1 Flexibility and Change Management

It is important that the EnterCap data model evolve over time. Given the daily process horizon of the Corporate Treasurer, whose processes must continue uninterrupted, the data model must have great flexibility to cope with organizational change. For example, it should be possible to assimilate an acquired company rapidly into the working capital platform to gain capital efficiencies.

To allow comprehensive utilization throughout the enterprise, the data model must accommodate a high rate of change. To achieve this, data types (as well as business rules) not found in the common model can be set up as exceptions, although if the data model is comprehensive and well-defined exceptions will be quite rare. In some cases exceptions will be ‘leading edge’ cases subsequently accommodated in the EnterCap data model. To ensure continuity of operations, user instances will need to be maintained over time using a formal change process for inserting and removing elements from the model. To ensure that changes can be applied across the entire user community, backwards compatibility will need to be maintained for a significant period to allow implementation of changes to take effect

2.5.2 Infrastructure Compatibility

Increased efficiency benefits will accrue for companies that use EnterCap if they can transfer ‘rich data’ among each other and through the payments-networks provided by their banks. While a key feature of EnterCap is that it does not depend on ‘semantic congruence’ among counterparties, which would render it inflexible, when such congruence can be achieved it should be supported. EnterCap should there as far as possible publish rich data in such as way that it can be carried by widely used payments infrastructure such as ACH and SWIFT and imported by widely used complementary infrastructure such as systems for accounting, ERP, CRM, purchasing or market exchange.

3. Architecture

3.1 Functionality

3.1.1 Implantation of Data Model Between Banks and Corporations: Extracting Intelligence from Collections and Disbursements

The EnterCap data model enables assimilation across an organization and among organizations of externally-facing financial processes by: (a) preserving the linkage of commercial transactions to financial transactions in financial processes and analyses; (b) providing capture of financial transactions in a manner suitable for aggregation and analysis, which is achieved by the logical mapping of specific transaction instances to the EnterCap data model; and (c) enabling aggregation, tracking and analysis of financial transactions across the organization, and, where appropriate, among organizations.

While each corporation will use a different instance of the EnterCap data model, the logical hierarchy of the data model will be common among all instances, so that data extracted from any one corporation will be comparable to all others and can be aggregated for statistical analysis.

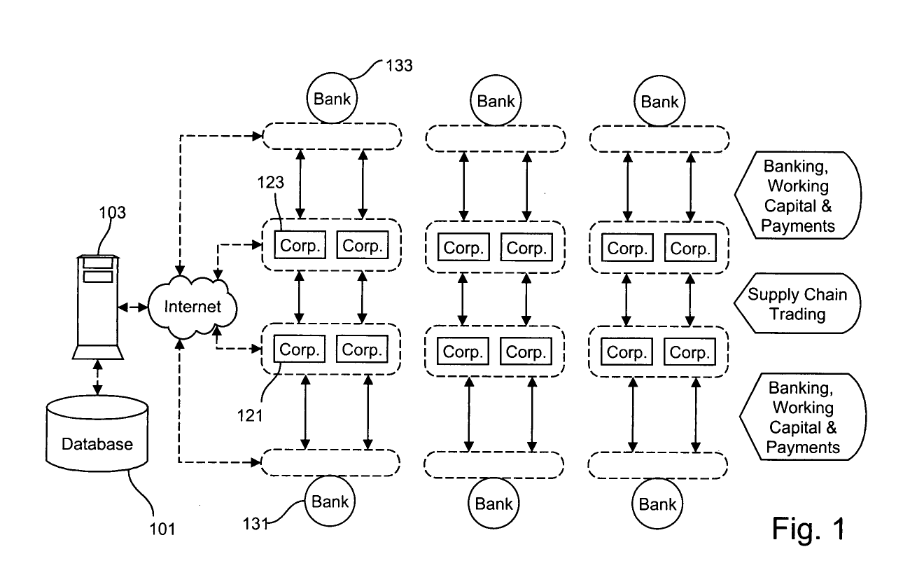

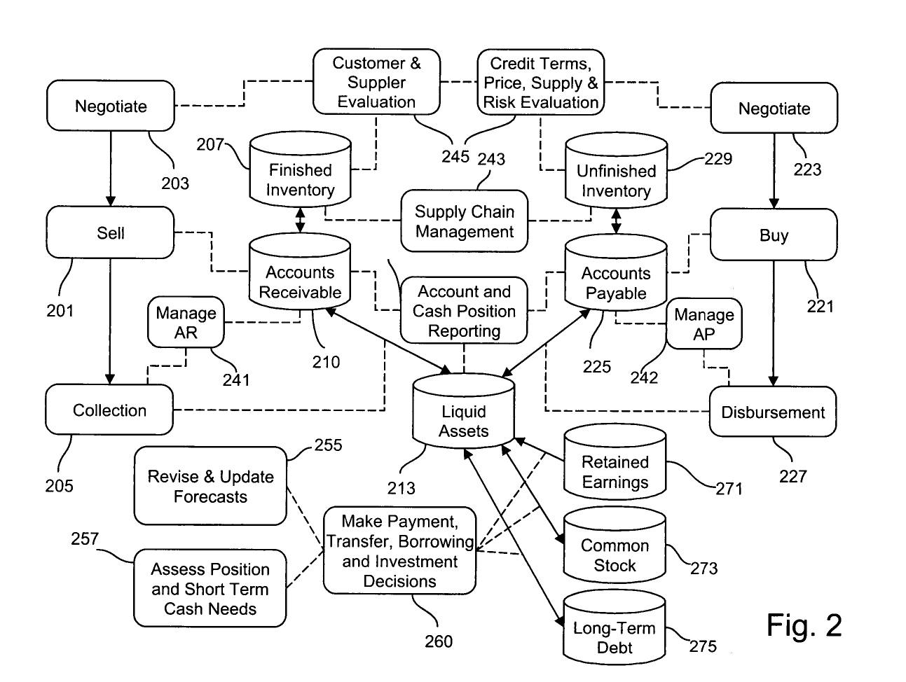

The implantation of this common data model within the externally-facing financial processes of corporations and between banks and corporations is illustrated in FIG. 1. More detail of the nature of each such process is given in FIG. 2.

As shown in FIG. 1, the data which conforms to the EnterCap common data model may be stored in central database indicated as seen at 101 which is accessible to a server 103. The server 103 captures data and provides a variety of processing services using the data by performing functions implemented as Web services. The database 101 and server 103 may be implemented using available database management systems which operate in combination with application server systems. Web services provide a standard way to discover, publish and invoke applications and execute processes such as transactions through the exchange of documents formatted according to industry standards for machine readable syntax and semantics, inter alia XML documents. The World Wide Web Consortium (W3C) and other standards bodies continue to establish the core standards that enable service consumers to obtain access to data and processing services in standard ways, reducing barriers to system interoperability. See, for example, Developing Java Web Services: Architecting and Developing Secure Web Services Using Java by Ramesh Nagappan et. al, John Wiley & Sons; (February 2003) ISBN: 0471236403. Existing packaged solutions, such as the Oracle 9i Application Server, provide integrated RDBMS and Web server software systems which may be employed to implement the invention.

The data stored in the database 101 is captured by Web services invoked by banks and corporations when commercial and financial processes are performed. As seen in FIG. 1, and by way of example, if a corporation 121 purchases goods or services from a corporation 123, the sales transaction may require a subsequent financial transaction to settle the trade, reflected as a financial withdrawal from the account of the buyer corporation 121 held at a bank 131 to fund a payment from bank 131 to a bank 133 which funds a deposit into the account of the seller corporation 123 at bank 133. The data which describes this sales transaction is captured by the participants (corporations 121 and 123 and banks 131 and 132) invoking Web services which capture not only financial transaction data (e.g. bank account, amount and date) but also “rich data” which provides information on the underlying commercial transaction, as described in more detail later.

As seen in FIG. 1, the common data model captures data elements (shown schematically in FIG. 1 by the dashed line rounded rectangles) which describe banking processes (e.g. payments, withdrawals, transfers of working capital between accounts) as well as commercial processes which reflect supply chain trading between corporations and their customers and suppliers.

The manner in which conventional bank transaction data is combined in the common data model with rich data that is captured during supply chain transactions is shown in FIG. 2 which depicts the manner in which the data model is used by a single corporation. The common data model contains data which describes the state of a variety of asset accounts depicted in FIG. 2 by stored data. Transactions which reflect changes to or the evaluation of these asset accounts are performed by financial or supply chain processes, shown in FIG. 2 by rounded rectangles which may be performed in whole or in part by invoking Web services which analyze or capture data in the data model.

The corporation sells its goods or services at 201 following a negotiation process at 203. Thereafter, a collection process at 205 is completed. This sale is accompanied by related activities: goods are transferred from finished inventory seen at 207 to the buyer (or services rendered using available resources in the case of service providers rather than manufacturers or distributors), resulting in an increase in accounts receivable at 210. When the collection 205 is completed, this signifies that banking payment has been made by the buyer (the counterparty sold to and delivered to) into a liquid assets account at 213, and accounts receivable is reduced by the amount received.

The corporation also purchases goods as seen at 221 following a negotiation with the seller at 223. This purchase is accompanied by related activities: goods are received into unfinished inventory seen at 229 from the supplier (or services consumed), resulting in an increase in accounts payable at 225, normally followed by a disbursement to the supplier at 227.

All of these banking and supply chain transactions are reflected by data captured by the database in accordance with the common data model. The resulting data may then be used by various management processes, including accounts receivable management seen at 241 which manages collections. Supply chain management functions seen at 243 utilize data stored in the database to make purchasing decisions. Seen at 245 sales targeting decisions, pricing and credit terms decisions may be enhanced with analytical systems operating over the data captured in the database. Equally, purchasing decisions such as supplier selection and pricing decisions seen at 245 may be supported by analytical systems operating over the data captured in the database covering such issues concerning customers or suppliers such as past delivery performance, payment history, pricing history and the like, to assist in the negotiation processes as 203 and 223. These analytical systems may combine the data in the database with that supplied by other firms also using the common data model and/or data supplied by agencies such as credit bureaus.

Asset management functions may be performed utilizing the data in the database. Business forecasts based on historical data may be created at 255, the corporation's current cash position and short term needs may be assessed as seen at 257, and as a result of these evaluations, decisions may be made concerning the timing and amounts of payments, transfers between accounts, borrowing to meet cash flow needs, and investment decisions, all of which may result in banking transactions reflecting funds transfers between one or more liquid asset accounts and accounts for retained earnings 271, common stocks 273 and long term debt 275.

3.1.2 Application Instances Working Off a Normalized Data Set

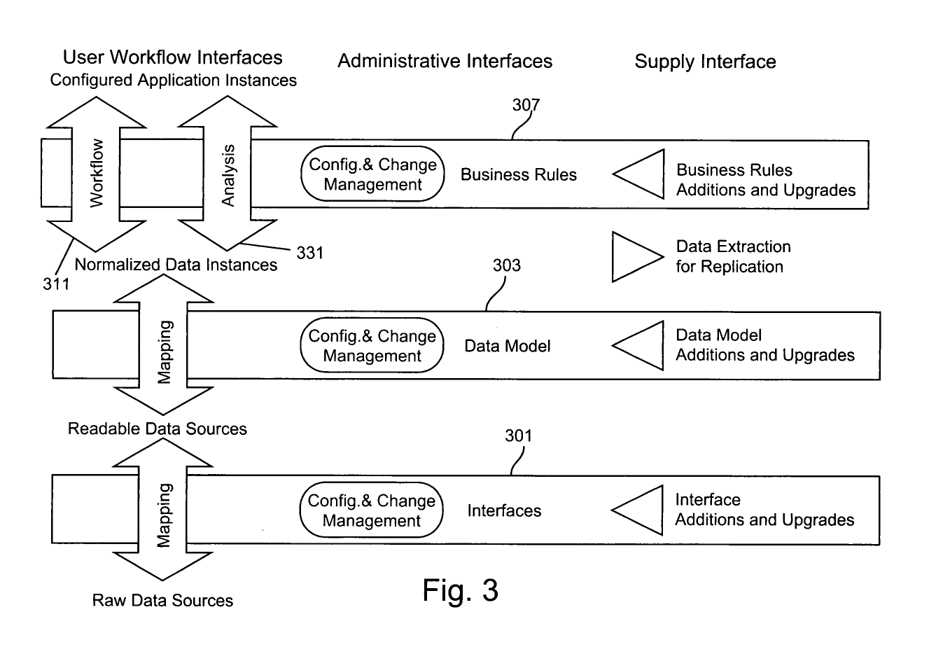

Each process consists of a configured application instance working off a normalized data set as illustrated in FIG. 3. A key feature of the EnterCap solution is that any subsequent process that is implemented is another configured application instance which operates over the same normalized data set as that used by the first process to be implemented.

As seen in FIG. 3, banking and supply transactions may yield data in a form that must first be made “readable” by interfaces 301 so that it can be supplied to the common data model 303 which maps the captured data into normalized data instances that are made available to applications 307 which perform workflow processes at 311 as financial functions are performed, or analysis processes at 331 which provide needed information about the status and history of the corporations financial and supply chain activities. The interfaces 301, the structure and content of the common data model 303, and the business rules that govern the applications 307 which perform workflow and analysis functions, may each be changed, and new interfaces, data model elements, and business rules may be added as needed.

“Normalized” in this context is defined as a payment transaction instance mapped to the EnterCap data model, including retention of a full set of ‘rich data’ that defines the commercial transaction underlying the financial transaction. The “rich data” that supplements the payment transaction data, as defined by the common data model, includes but is not limited to data describing the following:

(a) Sale or Purchase Counterparty—referencing internal and/or external directory

(b) Sale or Purchase contract or agreement reference

(c) Purchase order

(d) Sale or Purchase account reference, sellers account and buyers account

(e) Sale or Purchase invoice reference

(f) Shipping Counterparties—referencing internal and/or external directory

(g) Shipping contract or agreement references

(h) Shipping account

(i) Shipping invoice reference

(j) Transaction date

(k) Shipping dates, including hierarchy of partial shipping dates

(l) Receipt references, including partial receipt and/or sub-standard receipt, being receipt of damaged or non-functioning or substandard items or items in error, or inadequate services

(m) Deduction or discount references

(n) Revision references

(o) Payment counterparties, including correspondents

(p) Payment accounts, including correspondents

In each case, the “references” may be singular or plural, and may be hierarchical in each case: for example, a customer account may contain sub-accounts beneath it in a hierarchical taxonomy.

In addition, as ‘semantic web’ processes become available as process standards defined by the World Wide Web consortium and others, extending XML concepts beyond syntax to dynamic semantic processes, some or all of the references within an EnterCap transaction document or string, rather than being data itself may be calls on specific locations on the World Wide Web where the detailed data of that specific reference may be accessed, rather than the data itself, in the manner of a hyperlink in the World Wide Web. These specific places called on may be controlled by one of the counterparties to the payment transaction, by a partner in the transaction such as a shipping company or by another third party, for example an escrow agent who holds the reference data in escrow so that it may be referenced but not amended by any of the counterparties.

3.1.2.1 Transaction Document or String, Such as an XML Document

Web services are invoked by supplying XML documents (request messages) and the Web service returns result data in the form of XML response documents. To achieve the goals of EnterCap, documents reflecting transactions must be structured to execute as a machine-readable payment transaction (the transfer of value from one financial account to another) and yet carry (or reference in a machine-executable manner) the data that may used to link the payment to the commercial transaction to which it relates in a manner rich enough not only to conclude the settlement of the commercial transaction automatically but also to provide information for subsequent analysis. In the preferred embodiment, transaction documents are XML documents each of which has a format specified by an XML schema.

The documents may be accretive, such that if several payment transactions were required to complete the settlement of a commercial transaction, the final transaction in the process (being the transaction which transferred funds into the vendor's account) would carry references to prior transactions in the payment process (for example a payment from the purchaser's account at their paying bank to a correspondent bank).

An example of such a document as it arrives at the vendor's bank (payee bank) might include the following data (without being limited to that data):

(a) Transaction priority

(b) Purchase Order Number

(c) Payor ID

(d) Payor Bank ID

(e) Payor Account Name

(f) Payor Account Number

(g) Payor Bank-Correspondent Bank Transaction Number

(h) Payor Bank-Correspondent Bank Transaction Date

(i) Payor Bank-Correspondent Bank Transaction Time

(j) Payor Bank-Correspondent Bank Transaction Amount

(k) Payor Bank-Correspondent Bank Transaction Currency

(l) Correspondent Bank ID

(m) Correspondent Bank Account Name

(n) Correspondent Bank Account Number

(o) Payment transaction number

(p) Payment transaction date

(q) Payment transaction time

(r) Payment transaction amount

(s) Payment transaction currency

(t) Payee Bank ID

(u) Payee Account Name

(v) Payee Account Number

(w) Invoice Number

(x) Full or Partial payment flag

(y) Discount Reference

(z) Shipping reference

(aa) Shipping receipt confirmation reference

3.1.3 Added-Value Services Built onto the Bank's Payment Services

The EnterCap business model entails solutions for working capital management being marketed as value-added services to corporations by banks. In this way, banks serve the traditional need that they have addressed for corporations, which is working capital need. Traditionally, banks' role was confined to lending. In the EnterCap business model, banks will address working capital management for corporations not only through lending but also through the provision of risk-management tools. Using EnterCap, the banks will scale their payments business within a corporate banking relationship, since the EnterCap platform is built onto payments services, and reduce their lending business within a corporate relationship. The efficiency gains to the customer are such that their banking relationship is enhanced rather than strained by this change.

Viewed from the bank's product perspective, EnterCap solutions build on traditional valued-added products in the bank's payment business. Although many banks have developed cash management services for customers that integrate bank account information, there has been little development by banks of services that link cash outcomes to the commercial events that drive them. In addition, bank services have tended to remain in ‘product silos’ that do not easily inter-connect at an information level, constraining their value to the customer.

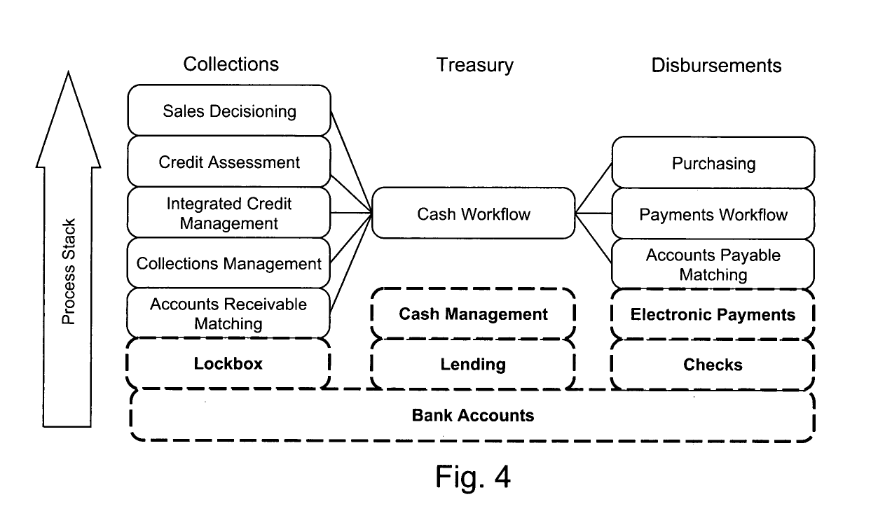

EnterCap will build additional workflow and analysis components onto traditional bank payments products, moving up the ‘process stack’ within corporations (see FIG. 4). The EnterCap solution encompasses any of the processes in the process stack that lie above traditional banking payments products as seen in FIG. 4 as dashed line rounded rectangles.

3.1.4 Application and Data Model Implantation Within Various Stages of the Externally-Facing Financial Activities of the Corporation

Viewed from the perspective of the corporation as opposed to the bank, EnterCap solutions operate at different stages within the externally-facing commercial and financial activities of corporations as depicted in FIG. 2. This is simply a different perspective of the same application instances as seen in FIG. 4, and the same design necessarily applies: any subsequent process that is implemented is another configured application instance but operating over the same normalized data set as that used by the first process to be implemented.

In fact, the applications rely not only on a common data model, but within a corporation they must share data to be effective: for example the forecasting routine within the Cash Workflow application is significantly more accurate when using probabilities supplied by the Integrated Credit Management application.

Conclusion

It is to be understood that the methods and apparatus which have been described above are merely illustrative applications of the principles of the invention. Numerous modifications may be made by those skilled in the are without departing from the true spirit and scope of the invention.

What is claimed is:

1. A method of managing supply chain transactions between a business organization and its customers and suppliers comprising, in combination, the steps of:
establishing a standard data model which defines the content of data representing said transactions, said data model specifying the content of data describing individual financial payment transactions performed by said bank on behalf of said business organization and additional data specifying the nature of the underlying commercial transaction between said business organization and its customer or supplier which gives rise to each of said financial payment transactions,
establishing a database system for storing data that conforms to said standard data model,
transmitting data to said database describing each given one of said financial payment transactions to be performed by said bank,
transmitting said additional data to said database specifying the nature of the underlying commercial transaction between said business organization and its customer or supplier which created the need for said given one of said financial payment transactions, and
in response to a request from said business organization, performing a selected one of a plurality of available data processing operations on the data in said database system.

2. A method of managing supply chain transactions between a business organization and its customers and suppliers as set forth in claim 1 wherein said data describing individual financial payment transactions includes an identification of a bank account of said business organization into which of from which a payment is to be made, the amount of the payment made, and the time said payment is made.

3. A method of managing supply chain transactions between a business organization and its customers and suppliers as set forth in claim 2 wherein said additional data specifying the nature of the underlying commercial transaction includes an identification of the customer or supplier with which the business organization deals and an identification of one or more documents relating to the commercial transaction.

4. A method of managing supply chain transactions between a business organization and its customers and suppliers as set forth in claim 3 wherein said documents include one or more members of the group comprising purchase orders, sales contracts, and invoices.

5. A method of managing supply chain transactions between a business organization and its customers and suppliers as set forth in claim 2 wherein said additional data specifying the nature of the underlying commercial transaction includes an information describing the manner in which goods or services are to be delivered.

6. A method of managing supply chain transactions between a business organization and its customers and suppliers as set forth in claim 5 wherein said information describing the manner in which goods or services are to be delivered includes information describing to one or more members of a group consisting of the shipping counterparties, shipping contracts, shipping invoices, and shipping dates.

7. A method of managing supply chain transactions between a business organization and its customers and suppliers as set forth in claim 1 wherein said step of transmitting data to said database describing each given one of said financial payment transactions is performed by a cash workflow procedure in which said business organization instructs its bank to make a payment.

8. A method of managing supply chain transactions between a business organization and its customers and suppliers as set forth in claim 7 wherein said cash workflow procedure in which said business organization instructs its bank to make a payment includes the transmission by said business organization to its bank of data which conforms to said data model and includes an identification of a bank account of said business organization into which or from which a payment is to be made, the amount of the payment made, and the time said payment is made.

9. A method of managing supply chain transactions between a business organization and its customers and suppliers as set forth in claim 8 wherein said additional data specifying the nature of the underlying commercial transaction includes an identification of the customer or supplier with which the business organization deals and an identification of one or more documents relating to the commercial transaction.

10. A method of managing supply chain transactions between a business organization and its customers and suppliers as set forth in claim 7 wherein said available data processing operations on the data in said database system include accounts receivable and collections management functions.

11. A method of managing supply chain transactions between a business organization and its customers and suppliers as set forth in claim 10 wherein said available data processing operations on the data in said database system further include customer credit assessment functions.

12. A method of managing supply chain transactions between a business organization and its customers and suppliers as set forth in claim 11 wherein said available data processing operations on the data in said database system further include accounts payable management functions.

13. A method of managing supply chain transactions between a business organization and its customers and suppliers as set forth in claim 10 wherein said available data processing operations on the data in said database system further include accounts payable workflow functions in which said business organization instructs its bank to make payments to suppliers.

14. A method of managing supply chain transactions between a business organization and its customers and suppliers as set forth in claim 7 wherein said step of transmitting data to said database describing each given one of said financial payment transactions is further performed by an accounts payable workflow procedure in which said business organization instructs its bank to make payments to suppliers.

15. A method of providing data processing services from a bank to a client business organization engaged in commercial supply chain business transactions comprising, in combination, the steps of:
establishing a standard data model which defines the content of data representing said transactions, said data model specifying the content of data describing individual financial payment transactions performed by said bank on behalf of said client business organization and additional data specifying the nature of the underlying commercial transaction between said business organization and its customers or suppliers which gives rise to said financial payment transactions,
establishing a database system for storing data that conforms to said standard data model,
employing said database to accept instruction data from said business organization to perform a given one of said financial payment transactions,
employing said database to accept said additional data specifying the nature of the underlying commercial transaction between said business organization and its customer or supplier associated with said financial payment transactions, and
in response to a request from said business organization, performing a selected one of a plurality of available data processing operations on the data in said database system.

16. A method of providing data processing services from a bank to a client business organization engaged in commercial supply chain business transactions as set forth in claim 15 wherein said instruction data includes an identification of a bank account of said business organization into which or from which a payment is to be made, the amount of the payment made, and the time said payment is made.

17. A method of providing data processing services from a bank to a client business organization engaged in commercial supply chain business transactions as set forth in claim 16 wherein said additional data specifying includes an identification of the customer or supplier with which the business organization deals and an identification of one or more documents relating to the commercial transaction.

18. A method of providing data processing services from a bank to a client business organization engaged in commercial supply chain business transactions as set forth in claim 15 wherein said available data processing operations on the data in said database system include accounts receivable and collections management functions.

19. A method of providing data processing services from a bank to a client business organization engaged in commercial supply chain business transactions as set forth in claim 18 wherein said available data processing operations on the data in said database system further include customer credit assessment functions.

20. A method of providing data processing services from a bank to a client business organization engaged in commercial supply chain business transactions as set forth in claim 15 wherein said step of accepting payment instruction data is performed by an accounts payable workflow procedure in which said business organization instructs its bank to make payments to suppliers.
